(19) United States
(12) Patent Application Publication
(10) Pub. No.: US 2026/0175820 A1
(43) Pub. Date: Jun. 25, 2026

(54) WINDSHIELD ICE SCRAPER DEVICE

(71) Applicant: Leon Dea, Magna, UT (US)

(72) Inventor: Leon Dea, Magna, UT (US)

(21) Appl. No.: 18/990,053

(22) Filed: Dec. 20, 2024

(51) Int. Cl. B60S 3/04

(52) U.S. Cl. CPC B60S 3/045

(57) ABSTRACT

A windshield ice scraper device includes a handle that has a finger slot to accommodate fingers of a user when the user grips the handle. The handle has a first attachment element and a second attachment element each disposed on opposing ends of the handle with respect to each other. A first ice scraper is removably attachable to the first attachment element to rest against a windshield of a vehicle when the user grips the handle. A second ice scraper is removably attachable to the second attachment element to rest against the windshield of the vehicle when the user grips the handle. The handle curves upwardly between the first attachment element and the second attachment element to direct each of the first ice scraper and the second ice scraper at a downward angle onto the windshield when the user grips the handle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to ice scraper devices and more particularly pertains to a new ice scraper device for scraping ice from a windshield in two directions. The device includes a handle that is curved between a first attachment element and a second attachment element. The device includes a first ice scraper that is removably attachable to the first attachment element and a second ice scraper that is removably attachable to the second attachment element. Each of the first ice scraper and the second ice scraper scrape ice from the windshield when the user moves the handle back and forth in a sideways motion to scrape the ice in two directions.

### (2) Description of Related Art Including Information Disclosed Under 37 CFR 1.97 and 1.98

The prior art relates to ice scraper devices including: a variety of ice scraper devices that each at least includes a pair of ice scrapers and a handle extending between the pair of ice scrapers; an ornamental design for a frost and ice scraper that includes a handle which has a finger slot extending laterally through the handle and a pair of ice scrapers being attached to opposing ends of the handle. In no instance does the prior art disclose a windshield ice scraper device that includes a handle which is curved between a first attachment element and a second attachment element and a first ice scraper that is removably attachable to the first attachment element and a second ice scraper that is removably attachable to the second attachment element.

### BRIEF SUMMARY OF THE INVENTION

An embodiment of the disclosure meets the needs presented above by generally comprising a handle that has a finger slot to accommodate fingers of a user when the user grips the handle. The handle has a first attachment element and a second attachment element each disposed on opposing ends of the handle with respect to each other. A first ice scraper is removably attachable to the first attachment element to rest against a windshield of a vehicle when the user grips the handle. A second ice scraper is removably attachable to the second attachment element to rest against the windshield of the vehicle when the user grips the handle. The handle curves upwardly between the first attachment element and the second attachment element to direct each of the first ice scraper and the second ice scraper at a downward angle onto the windshield when the user grips the handle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a windshield ice scraper device according to an embodiment of the disclosure.

FIG. 2 is an exploded front perspective view of an embodiment of the disclosure.

FIG. 3 is a top view of an embodiment of the disclosure.

FIG. 4 is a left side view of an embodiment of the disclosure.

FIG. 5 is a front view of an embodiment of the disclosure.

FIG. 6 is a cross sectional view taken along line 6-6 of FIG. 3 of an embodiment of the disclosure.

FIG. 7 is a perspective view of an alternative embodiment of the disclosure.

FIG. 8 is a perspective in-use view of an embodiment of the disclosure.

### DETAILED DESCRIPTION OF THE INVENTION

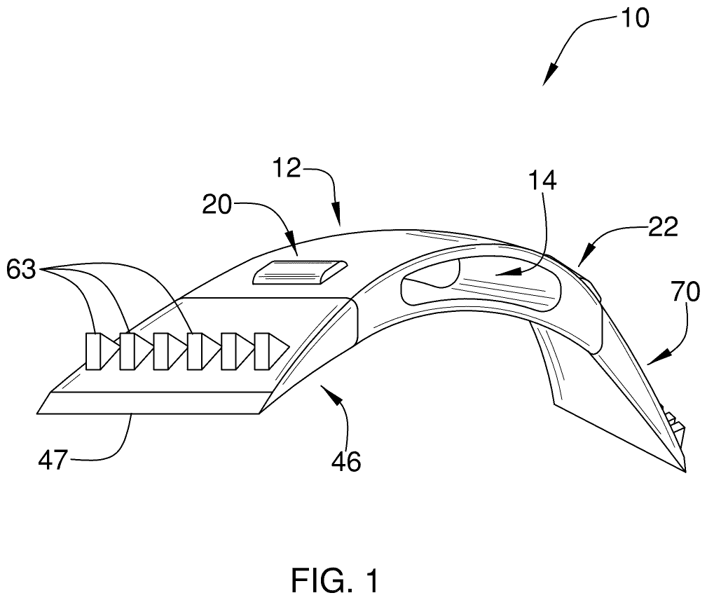

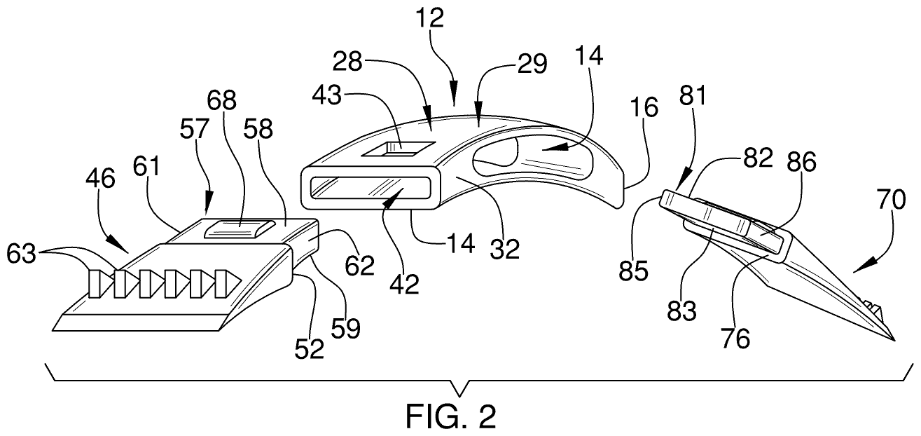

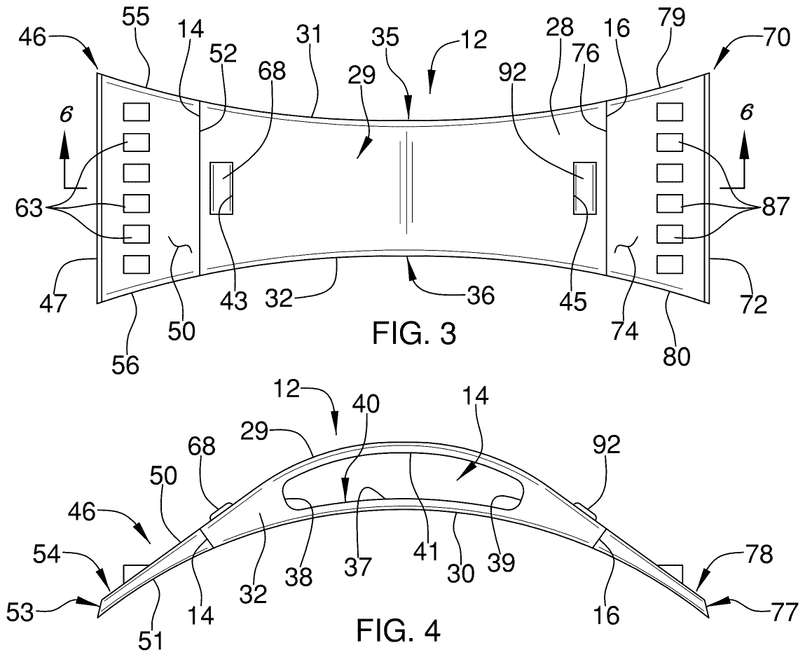

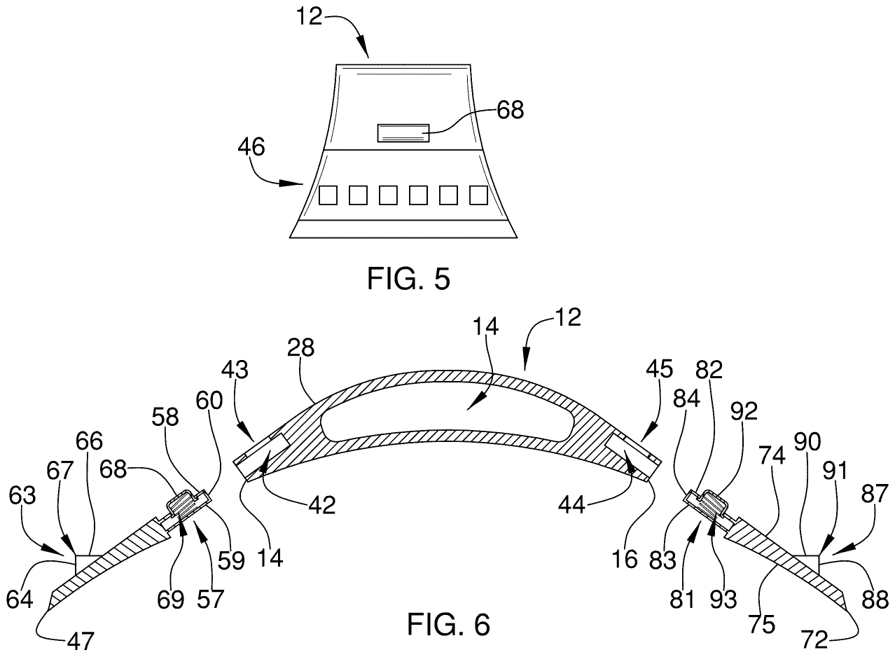

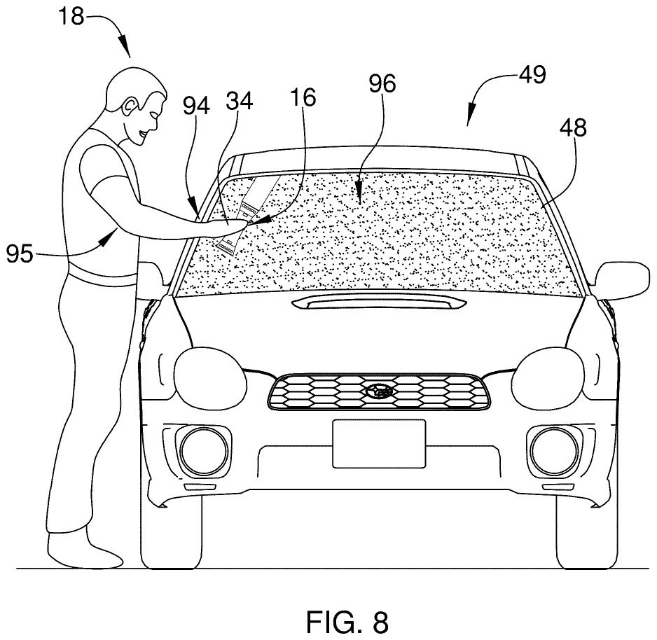

With reference now to the drawings, and in particular to FIGS. 1 through 8 thereof, a new ice scraper device embodying the principles and concepts of an embodiment of the disclosure and generally designated by the reference numeral 10 will be described.

As best illustrated in FIGS. 1 through 8, the windshield ice scraper device 10 generally comprises a handle 12 has a finger slot 14 which extends laterally through the handle 12. Furthermore, fingers 16 of a user 18 can be extended through the finger slot 14 when the user 18 grips the handle 12 to enhance the ability of the user 18 to maintain their grip on the handle 12. The handle 12 has a first attachment element 20 and a second attachment element 22. Additionally, each of the first attachment element 20 and the second attachment element 22 is disposed on opposing ends of the handle 12 with respect to each other.

The handle 12 has a first end 24 and a second end 26 and an outer wall 28 extending between the first end 24 and the second end 26; the outer wall 28 has a top side 29 and a bottom side 30 and a first lateral side 31 and a second lateral side 32. The bottom side 30 curves upwardly toward the top side 29 between the first end 24 and the second end 26. Additionally, the top side 29 curves upwardly away from the bottom side 30 between the first end 24 and the second end 26. The top side 29 has a radius of curvature which is less than a radius of curvature of the bottom side 30 such that the top side 29 conforms to curvature of a palm 33 of a hand 34 of the user 18 when the hand 34 of the user 18 is placed on the top side 29 to grip the handle 12. Each of the first lateral side 31 and the second lateral side 32 curves toward a center of the handle 12 between the first end 24 and the second end 26 such that each of the first end 24 and the second end 26 has a width which is greater than a distance between a middle point 35 of the first lateral side 31 and a middle point 36 of the second lateral side 32. Furthermore, each of the first lateral side 31 and the second lateral side 32 orients the hand 34 of the user 18 to extend between the middle point 35 of the first lateral side 31 and the middle point 36 of the second lateral side 32 when the hand 34 of the user 18 is placed on the top side 29 to grip the handle 12.

The finger slot 14 extends through the first lateral side 31 and the second lateral side 32 such that the fingers 16 of the user 18 curl into the finger slot 14 when the hand 34 of the user 18 is positioned to extend between the middle point 35 of the first lateral side 31 and the middle point 36 of the second lateral side 32. Furthermore, the finger slot 14 is elongated along an axis extending between the first end 24 and the second end 26 to accommodate all of the fingers 16 of the user 18 when the user 18 grips the handle 12. The finger slot 14 has a bounding surface 37 and the bounding surface 37 has a primary end 38 and a secondary end 39 and a lower side 40 and an upper side 41. Each of the lower side 40 and the upper side 41 extends between the primary end 38 and the secondary end 39. Additionally, each of the primary end 38 and the secondary end 39 is rounded such that the finger slot 14 has an ovoid shape to accommodate curvature of the fingers 16 of the user 18 when the fingers 16 of the user 18 are curled into the finger slot 14. The lower side 40 of the bounding surface 37 is co-arcuate with the bottom side 30 of the outer wall 28 of the handle 12 and the upper side 41 of the bounding surface 37 is co-arcuate with the top side 29 of the outer wall 28 of the handle 12. The finger slot 14 is centrally located between the first end 24 and the second end 26 to centrally locate the hand 34 of the user 18 on the top side 29 of the outer wall 28 when the user 18 grips the handle 12.

The first end 24 has a first well 42 extending toward the second end 26 and the first well 42 is positioned closer to the top side 29 of the outer wall 28 of the handle 12 than the bottom side 30 of the outer wall 28 of the handle 12. The handle 12 has a first opening 43 extending through the top side 29 of the outer wall 28 and into the first well 42. Furthermore, the first well 42 and the first opening 43 define the first attachment element 20 of the handle 12. The first opening 43 is elongated along an axis extending between the first lateral side 31 and the second lateral side 32 of the outer wall 28 of the handle 12 and the first opening 43 is positioned between the first end 24 and the primary end 38 of the bounding surface 37 of the finger slot 14.

The second end 26 has a second well 44 extending toward the first end 24 and the second well 44 is positioned closer to the top side 29 of the outer wall 28 of the handle 12 than the bottom side 30 of the outer wall 28 of the handle 12. The handle 12 has a second opening 45 extending through the top side 29 of the outer wall 28 and into the second well 44. Additionally, the second well 44 and the second opening 45 define the second attachment element 22 of the handle 12. The second opening 45 is elongated along the axis extending between the first lateral side 31 and the second lateral side 32 of the outer wall 28 of the handle 12 and the second opening 45 is positioned between the second end 26 and the secondary end 39 of the bounding surface 37 of the finger slot 14.

A first ice scraper 46 is removably attachable to the first attachment element 20 of the handle 12. The first ice scraper 46 has a first scraping edge 47 which is distally located with respect to the first attachment element 20 when the first ice scraper 46 is removably attached to the first attachment element 20. Furthermore, the first scraping edge 47 is positionable to rest against a windshield 48 of a vehicle 49 when the user 18 grips the handle 12. The vehicle 49 may be a passenger vehicle or a cargo vehicle, for example, or any other type of motorized vehicle that is located in an area that experiences winter weather conditions.

The first ice scraper 46 has an upper surface 50 and a lower surface 51 each extending between a rear end 52 of the first ice scraper 46 and the first scraping edge 47. The lower surface 51 curves upwardly toward the upper surface 50 between the rear end 52 and the first scraping edge 47. Additionally, the upper surface 50 has a front portion 53 which intersects the lower surface 51 at an acute inside angle to define the first scraping edge 47. The upper surface 50 has a rear portion 54 extending between the rear end 52 and the front portion 53; the rear portion 54 is oriented at an obtuse inside angle with the front portion 53. The first ice scraper 46 has a first sidelong surface 55 and a second sidelong surface 56 each extending between the first scraping edge 47 and the rear end 52. Each of the first sidelong surface 55 and the second sidelong surface 56 curves inwardly toward a center of the first ice scraper 46 between the first scraping edge 47 and the rear end 52. Furthermore, the rear end 52 has a width which is less than a width of the first scraping edge 47 such that the first scraping edge 47 can engage a maximum width of ice 96 on the windshield 48.

A first housing 57 is coupled to and extends away from the rear end 52 of the first ice scraper 46. The first housing 57 has an upper wall 58 lying on a plane which is spaced downwardly from the rear portion 54 of the upper surface 50 of the first ice scraper 46. Additionally, the first housing 57 has a lower wall 59 lying on a plane which is spaced upwardly from the lower surface 51 of the first ice scraper 46. The first housing 57 has a rear wall 60 extending between the upper wall 58 and the lower wall 59 and the first housing 57 has a first sidelong wall 61 and a second sidelong wall 62. Each of the first sidelong wall 61 and the second sidelong wall 62 curves inwardly toward a center of the first housing 57 between the rear end 52 of the first ice scraper 46 and the rear wall 60 of the first housing 57.

The first housing 57 is insertable into the first well 42 in the first end 24 of the handle 12 having the rear end 52 of the first ice 96 scrapper abutting the first end 24 of the handle 12 when the first housing 57 is fully seated into the first well 42. Furthermore, the first scraping edge 47 is oriented parallel to the first end 24 such that the first scraping edge 47 is oriented to scrape the ice 96 on the windshield 48 when the user 18 urges the handle 12 to travel in a sideways motion on the windshield 48. Each of the first sidelong surface 55 and the second sidelong surface 56 of the first ice scraper 46 is aligned with and is oriented co-arcuate with a respective one of the first lateral side 31 and the second lateral side 32 of the outer wall 28 of the handle 12 when the first housing 57 is fully seated into the first well 42. Furthermore, each of the first sidelong surface 55 and the second sidelong surface 56 inhibit the hand 34 of the user 18 from sliding along the first ice scraper 46 when the user 18 urges the handle 12 to travel in the sideways motion on the windshield 48.

A plurality of first ridges 63 is each coupled to and extends upwardly from the rear portion 54 of the upper surface 50 of the first ice scraper 46. The plurality of first ridges 63 engage the ice 96 on the windshield 48 when the user 18 orients the first ice scraper 46 in an inverted orientation on the windshield 48 to break the ice 96. Each first ridge of the plurality of first ridges 63 has a forward surface 64 which is oriented perpendicular to a rear surface 66 to define a point 67. The point 67 of each first ridge 63 of the plurality of first ridges 63 penetrates the ice 96 to break the ice 96 when the ice 96 is too thick for the first ice scraper 46. The plurality of first ridges 63 is evenly spaced apart from each other and is distributed between the first sidelong surface 55 and the second sidelong surface 56 of the first ice scraper 46. Additionally, the plurality of first ridges 63 is positioned closer to the front portion 53 of the upper surface 50 of the first ice scraper 46 than the rear end 52 of the first ice scraper 46.

A first lock 68 is movably integrated into the upper wall 58 of the first housing 57 and the first lock 68 is biased to move upwardly from the upper wall 58. The first lock 68 is urgeable to travel downwardly into the upper wall 58 such that the first lock 68 can be depressed by the user 18. The first lock 68 extends upwardly through the first opening 43 in the top side 29 of the outer wall 28 of the handle 12 when the first housing 57 is fully seated in the first well 42 for removably securing the first housing 57 in the first well 42. Conversely, the first lock 68 is displaced from the first opening 43 when the first lock 68 is urged to travel downwardly into the upper wall 58. Furthermore, the first housing 57 can be removed from the first well 42 when the user 18 depresses the first lock 68 for detaching the first ice scraper 46 from the handle 12.

A first biasing member 69 is provided and the first biasing member 69 is positioned within the first housing 57. The first biasing member 69 extends between the lower wall 59 of the first housing 57 and the first lock 68. Furthermore, the first biasing member 69 biases the first lock 68 to travel upwardly from the upper wall 58 of the first housing 57. The first biasing member 69 may comprise a spring or other type of linear biasing member and the first lock 68 may comprise a button or a knob or other type of protrusion that can be manipulated by the user 18.

A second ice scraper 70 is removably attachable to the second attachment element 22 of the handle 12. The second ice scraper 70 has a second scraping edge 72 which is distally located with respect to the second attachment element 22 when the second ice scraper 70 is removably attached to the second attachment element 22. Furthermore, the second scraping edge 72 is positionable to rest against the windshield 48 of the vehicle 49 when the user 18 grips the handle 12. The handle 12 is structured to curve upwardly between the first attachment element 20 and the second attachment element 22. Furthermore, each of the first ice scraper 46 and the second ice scraper 70 is directed at a downward angle onto the windshield 48 when the user 18 grips the handle 12 such that each of the first scraping edge 47 and the second scraping edge 72 is positioned at a preferred orientation with the windshield 48 to scrape ice 96 from the windshield 48.

The second ice scraper 70 has an upper surface 74 and a lower surface 75 each extending between a rear end 76 of the second ice scraper 70 and the second scraping edge 72. The lower surface 75 of the second ice scraper 70 curves upwardly toward the upper surface 74 of the second ice scraper 70 between the rear end 76 of the second ice scraper 70 and the second scraping edge 72. The upper surface 74 of the second ice scraper 70 has a forward portion 77 which intersects the lower surface 75 of the second ice scraper 70 at an acute inside angle to define the second scraping edge 72. Additionally, the upper surface 74 of the second ice scraper 70 has a back portion 78 extending between the rear end 76 of the second ice scraper 70 and the forward portion 77 and the back portion 78 is oriented at an obtuse inside angle with the forward portion 77.

The second ice scraper 70 has a first sidelong surface 79 of the second ice scraper 70 and a second sidelong surface 80 of the second ice scraper 70 each extending between the second scraping edge 72 and the rear end 76 of the second ice scraper 70. Each of the first sidelong surface 79 of the second ice scraper 70 of and the second sidelong surface 80 of the second ice scraper 70 curves inwardly toward a center of the second ice scraper 70 between the second scraping edge 72 and the rear end 76 of the second ice scraper 70. Furthermore, the rear end 76 of the second ice scraper 70 has a width that is less than a width of the second scraping edge 72 to engage a maximum width of ice 96 on the windshield 48.

A second housing 81 is coupled to and extends away from the rear end 76 of the second ice scraper 70. The second housing 81 has an upper wall 82 of the second housing 81 which lies on a plane that is spaced downwardly from the back portion 78 of the upper surface 74 of the second ice scraper 70. Additionally, the second housing 81 has a lower wall 83 of the second housing 81 which lies on a plane that is spaced upwardly from the lower surface 75 of the second ice scraper 70. The second housing 81 has a rear wall 84 of the second housing 81 extending between the upper wall 82 of the second housing 81 and the lower wall 83 of the second housing 81. Furthermore, the second housing 81 has a first sidelong wall 85 of the second housing 81 and a second sidelong wall 86 of the second housing 81.

Each of the first sidelong wall 85 of the second housing 81 and the second sidelong wall 86 of the second housing 81 curves inwardly toward a center of the second housing 81 between the rear end 76 of the second ice scraper 70 and the rear wall 84 of the second housing 81. The second housing 81 is insertable into the second well 44 in the second end 26 of the handle 12 having the rear end 76 of the second ice scraper 70 of the second ice 96 scrapper abutting the second end 26 of the handle 12 when the second housing 81 is fully seated into the second well 44. Furthermore, the second scraping edge 72 is oriented parallel to the second end 26 to scrape the ice 96 on the windshield 48 when the user 18 urges the handle 12 to travel in the sideways motion on the windshield 48. Each of the first sidelong surface 79 of the second ice scraper 70 and the second sidelong surface 80 of the second ice scraper 70 is aligned with and is oriented co-arcuate with a respective one of the first lateral side 31 and the second lateral side 32 of the outer wall 28 of the handle 12 when the second housing 81 is fully seated into the second well 44. Furthermore, each of the first sidelong surface 79 of the second ice scraper 70 and the second sidelong surface 80 of the second ice scraper 70 inhibit the hand 34 of the user 18 from sliding along the second ice scraper 70 when the user 18 urges the handle 12 to travel in the sideways motion on the windshield 48.

A plurality of second ridges 87 is each coupled to and extends upwardly from the back portion 78 of the upper surface 74 of the second ice scraper 70. The plurality of second ridges 87 engage the ice 96 on the windshield 48 when the user 18 orients the second ice scraper 70 in an inverted orientation on the windshield 48 to break the ice 96. Each second ridge 87 of the plurality of second ridges 87 has a front surface 88 of a respective second ridge 87 which is oriented perpendicular to a back surface 90 of the respective second ridge 87 to define a point 91 of the respective second ridge 87. The point 91 of each second ridge 87 of the plurality of second ridges 87 penetrates the ice 96 to break the ice 96 when the ice 96 is too thick for the second ice scraper 70. The plurality of second ridges 87 is evenly spaced apart from each other and is distributed between the first sidelong surface 79 of the second ice scraper 70 and the second sidelong surface 80 of the second ice scraper 70. Additionally, the plurality of second ridges 87 is positioned closer to the forward portion 77 of the upper surface 74 of the second ice scraper 70 than the rear end 76 of the second ice scraper 70.

A second lock 92 is movably integrated into the upper wall 82 of the second housing 81 and the second lock 92 is biased to move upwardly from the upper wall 82 of the second housing 81. Furthermore, the second lock 92 is urgeable to travel downwardly into the upper wall 82 of the second housing 81 such that the second lock 92 can be depressed by the user 18. The second lock 92 extends upwardly through the second opening 45 in the top side 29 of the outer wall 28 of the handle 12 when the second housing 81 is fully seated in the second well 44 for removably securing the second housing 81 in the second well 44. Conversely, the second lock 92 is displaced from the second opening 45 when the second lock 92 is urged to travel downwardly into the upper wall 82 of the second housing 81. The second housing 81 can be removed from the second well 44 when the user 18 depresses the second lock 92 for detaching the second ice scraper 70 from the handle 12.

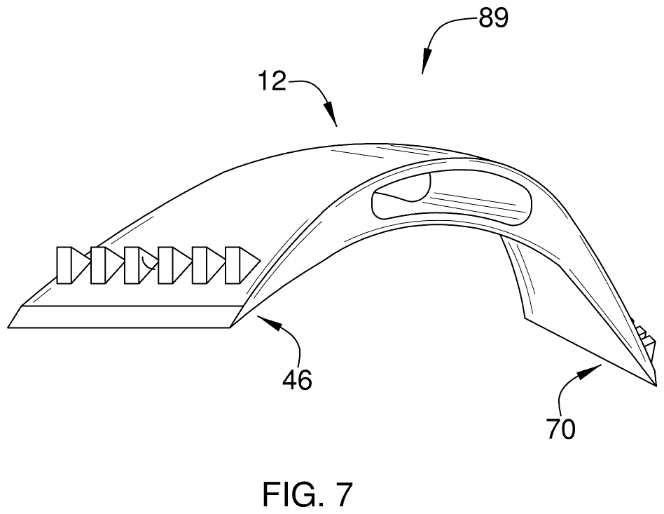

A second biasing member 93 is provided and the second biasing member 93 is positioned within the second housing 81. The second biasing member 93 extends between the lower wall 83 of the second housing 81 and the second lock 92 to bias the second lock 92 to travel upwardly from the upper wall 82 of the second housing 81. The second biasing member 93 may comprise a spring biasing member or other type of linear biasing member and the second lock 92 may comprise a button or a knob or other protrusion that can be manipulated by the user 18. In an alternative embodiment 89 as shown in FIG. 7, each of the first ice scraper and the second ice scraper and the handle are a unitary structure.

In use, each of the first ice scraper 46 and the second ice scraper 70 are attached to the handle 12 and the user 18 grips the handle 12 such that the hand 34 of the user 18 rests on the top side 29 of the outer wall 28 of the handle 12 and the fingers 16 of the user 18 curl into the finger slot 14. The user 18 can extend their fingers 16 and their hand 34 through the finger slot 14 and curl their fingers 16 around the bottom side 30 of the outer wall 28 of the handle 12 to grip the handle 12. Each of the first ice scraper 46 and the second ice scraper 70 are positioned against the windshield 48 of the vehicle 49 and the user 18 moves the handle 12 in a back and forth motion. Furthermore, the first scraping edge 47 and the second scraping edge 72 scrape the ice 96 from the windshield 48 when handle 12 moves back and forth to scrape the maximum amount of ice 96 from the windshield 48. Currently existing ice scrapers require an individual to apply force at an angle with the windshield 48 that can put strain on the individual's wrist and elbow. The handle 12 is oriented such that the user 18 can apply force at a perpendicular angle with the windshield 48 to reduce the strain on a wrist 94 of the user 18 and an elbow 95 of the user 18. Additionally, the handle 12 transfers the force of the user 18 pushing the handle 12 toward the windshield 48 into each of the first scraping edge 47 and the second scraping edge 72 to enhance efficiency with which the ice 96 can be scraped from the windshield 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A windshield ice scraper device for scraping ice in two directions, said device comprising:
a handle having a finger slot extending laterally through said handle wherein said finger slot is configured to have fingers of a user extended through said finger slot when the user grips said handle to enhance an ability of the user to maintain a grip on said handle, said handle having a first attachment element and a second attachment element, each of said first attachment element and said second attachment element being disposed on opposing ends of said handle;
a first ice scraper being removably attachable to said first attachment element of said handle, said first ice scraper having a first scraping edge being distally located with respect to said first attachment element when said first ice scraper is removably attached to said first attachment element wherein said first scraping edge is configured to rest against a windshield of a vehicle when the user grips said handle; and
a second ice scraper being removably attachable to said second attachment element of said handle, said second ice scraper having a second scraping edge being distally located with respect to said second attachment element when said second ice scraper is removably attached to said second attachment element wherein said second scraping edge is configured to rest against the windshield of the vehicle when the user grips said handle, said handle being structured to curve upwardly between said first attachment element and said second attachment element wherein each of said first ice scraper and said second ice scraper is configured to be directed at a downward angle onto the windshield when the user grips said handle such that each of said first scraping edge and said second scraping edge is positioned at a preferred orientation with the windshield to scrape ice from the windshield.

2. The windshield ice scraper device according to claim 1, wherein:
said handle has a first end and a second end and an outer wall extending between said first end and said second end;
said outer wall has a top side and a bottom side and a first lateral side and a second lateral side;
said bottom side curves upwardly toward said top side between said first end and said second end;
said top side curves upwardly away from said bottom side between said first end and said second end;
said top side has a radius of curvature being less than a radius of curvature of said bottom side wherein said top side is configured to conform to curvature of a palm of the hand of the user when the hand of the user is placed on said top side to grip said handle; and
each of said first lateral side and said second lateral side curves toward a center of said handle between said first end and said second end such that each of said first end and said second end has a width being greater than a distance between a middle point of said first lateral side and a middle point of said second lateral side wherein each of said first lateral side and said second lateral side are configured to orient the hand of the user to extend between said middle point of said first lateral side and said middle point of said second lateral side when the hand of the user is placed on said top side to grip said handle.

3. The windshield ice scraper device according to claim 2, wherein:
said finger slot extends through said first lateral side and said second lateral side wherein said finger slot is configured to have the fingers of the user curling into said finger slot when the hand of the user is positioned to extend between said middle point of said first lateral side and said middle point of said second lateral side; and
said finger slot is elongated along an axis extending between said first end and said second end wherein said finger slot is configured to accommodate all of the fingers of the user when the user grips said handle.

4. The windshield ice scraper device according to claim 2, wherein:
said finger slot has a bounding surface;
said bounding surface has a primary end and a secondary end and a lower side and an upper side;
each of said lower side and said upper side extends between said primary end and said secondary end;
each of said primary end and said secondary end is rounded such that said finger slot has an ovoid shape wherein said finger slot is configured to accommodate curvature of the fingers of the user when the fingers of the user are curled into said finger slot;
said lower side of said bounding surface is co-arcuate with said bottom side of said outer wall of said handle;
said upper side of said bounding surface is co-arcuate with said top side of said outer wall of said handle; and
said finger slot is centrally located between said first end and said second end wherein said finger slot is configured to centrally locate the hand of the user on said top side of said outer wall when the user grips said handle.

5. The windshield ice scraper device according to claim 2, wherein:
said first end of said handle has a first well extending toward said second end of said handle;
said first well is positioned closer to said top side of said outer wall of said handle than said bottom side of said outer wall of said handle;
said handle has a first opening extending through said top side of said outer wall and into said first well;
each of said first well and said first opening defines said first attachment element of said handle;
said first opening is elongated along an axis extending between said first lateral side and said second lateral side of said outer wall of said handle; and
said first opening is positioned between said first end and said primary end of a bounding surface of said finger slot.

6. The windshield ice scraper device according to claim 5, wherein:
said second end of said handle having a second well extending toward said first end of said handle;
said second well is positioned closer to said top side of said outer wall of said handle than said bottom side of said outer wall of said handle;
said handle has a second opening extending through said top side of said outer wall and into said second well;
each of said second well and said second opening defines said second attachment element of said handle;
said second opening is elongated along said axis extending between said first lateral side and said second lateral side of said outer wall of said handle; and
said second opening is positioned between said second end and said secondary end of said bounding surface of said finger slot.

7. The windshield ice scraper device according to claim 1, wherein:
said first ice scraper has an upper surface and a lower surface each extending between a rear end of said first ice scraper and said first scraping edge;
said lower surface curves upwardly toward said upper surface between said rear end and said first scraping edge;
said upper surface has a front portion which intersects said lower surface at an acute inside angle to define said first scraping edge;
said upper surface has a rear portion extending between said rear end and said front portion;
said rear portion is oriented at an obtuse inside angle with said front portion;
said first ice scraper has a first sidelong surface and a second sidelong surface each extending between said first scraping edge and said rear end;
each of said first sidelong surface and said second sidelong surface curves inwardly toward a center of said first ice scraper between said first scraping edge and said rear end such that said rear end has a width being less than a width of said first scraping edge wherein said first scraping edge is configured to engage a maximum width of ice on the windshield.

8. The windshield ice scraper device according to claim 7, wherein:
said handle has a first end;
said handle has a first well extending into said first end;
said windshield ice scraper device includes a first housing being coupled to and extending away from said rear end of said first ice scraper;
said first housing has an upper wall lying on a plane being spaced downwardly from said rear portion of said upper surface of said first ice scraper;
said first housing has a lower wall lying on a plane being spaced upwardly from said lower surface of said first ice scraper;
said first housing has a rear wall extending between said upper wall and said lower wall;
said first housing has a first sidelong wall and a second sidelong wall;
each of said first sidelong wall and said second sidelong wall curves inwardly toward a center of said first housing between said rear end of said first ice scraper and said rear wall of said first housing; and
said first housing is insertable into said first well in said first end of said handle having said rear end of said first ice scrapper abutting said first end of said handle when said first housing is fully seated into said first well having said first scraping edge being oriented parallel to said first end wherein said first scraping edge is configured to scrape the ice on the windshield when the user urges said handle to travel in a sideways motion on the windshield.

9. The windshield ice scraper device according to claim 8, wherein:
said handle has an outer wall;
said outer wall has a first lateral side and a second lateral side;
each of said first lateral side and said second lateral side is curved; and
each of said first sidelong surface and said second sidelong surface of said first ice scraper is aligned with and is oriented co-arcuate with a respective one of said first lateral side and said second lateral side of said outer wall of said handle when said first housing is fully seated into said first well wherein each of said first sidelong surface and said second sidelong surface are configured to inhibit the hand of the user from sliding along said first ice scraper when the user urges said handle to travel in the sideways motion on the windshield.

10. The windshield ice scraper device according to claim 8, wherein:
said handle has an outer wall;
said outer wall has a top side;
said outer wall has a first opening extending through said top side and into said first well in said first end of said handle;
said windshield ice scraper device includes a first lock being movably integrated into said upper wall of said first housing;
said first lock is biased to move upwardly from said upper wall;
said first lock is urgeable to travel downwardly into said upper wall wherein said first lock is configured to be depressed by the user;
said first lock extends upwardly through said first opening in said top side of said outer wall of said handle when said first housing is fully seated in said first well for removably securing said first housing in said first well; and
said first lock is displaced from said first opening when said first lock is urged to travel downwardly into said upper wall wherein said first housing is configured to be removed from said first well when the user depresses said first lock for detaching said first ice scraper from said handle.

11. The device according to claim 10, wherein:
said windshield ice scraper device includes a first biasing member being positioned within said first housing; and
said first biasing member extends between said lower wall of said first housing and said first lock to bias said first lock to travel upwardly from said upper wall of said first housing.

12. The windshield ice scraper device according to claim 1, wherein:
said second ice scraper has an upper surface and a lower surface each extending between a rear end of said second ice scraper and said second scraping edge;
said lower surface of said second ice scraper curves upwardly toward said upper surface of said second ice scraper between said rear end of said second ice scraper and said second scraping edge;
said upper surface of said second ice scraper has a forward portion which intersects said lower surface of said second ice scraper at an acute inside angle to define said second scraping edge;
said upper surface of said second ice scraper has a back portion extending between said rear end of said second ice scraper and said forward portion;
said back portion is oriented at an obtuse inside angle with said forward portion;
said second ice scraper has a first sidelong surface of said second ice scraper and a second sidelong surface of said second ice scraper each extending between said second scraping edge and said rear end of said second ice scraper; and
each of said first sidelong surface of said second ice scraper of and said second sidelong surface of said second ice scraper curves inwardly toward a center of said second ice scraper between said second scraping edge and said rear end of said second ice scraper such that said rear end of said second ice scraper has a width being less than a width of said second scraping edge wherein said second scraping edge is configured to engage a maximum width of ice on the windshield.

13. The windshield ice scraper device according to claim 12, wherein:
said handle has a first end and a second end;
said handle has a first well extending into said first end;
said handle has a second well extending into said second end;
said windshield ice scraper device includes a first housing being attached to said first ice scraper;
said windshield ice scraper device includes a second housing being coupled to and extending away from said rear end of said second ice scraper;
said second housing has an upper wall of said second housing lying on a plane being spaced downwardly from said back portion of said upper surface of said second housing;
said second housing has a lower wall of said second housing lying on a plane being spaced upwardly from said lower surface of said second housing;
said second housing has a rear wall of said second housing extending between said upper wall of said second housing and said lower wall of said second housing;
said second housing has a first sidelong wall of said second housing and a second sidelong wall of said second housing;
each of said first sidelong wall of said second housing and said second sidelong wall of said second housing curves inwardly toward a center of said second housing between said rear end of said second ice scraper and said rear wall of said second housing; and
said second housing is insertable into said second well in said second end of said handle having said rear end of said second ice scraper of said second ice scrapper abutting said second end of said handle when said second housing is fully seated into said second well having said second scraping edge being oriented parallel to said second end wherein said second scraping edge is configured to scrape the ice on the windshield when the user urges said handle to travel in the sideways motion on the windshield.

14. The windshield ice scraper device according to claim 13, wherein:
said handle has an outer wall;
said outer wall has a first lateral side and a second lateral side;
each of said first lateral side and said second lateral side is curved; and
each of said first sidelong surface of said second ice scraper and said second sidelong surface of said second ice scraper is aligned with and is oriented co-arcuate with a respective one of said first lateral side and said second lateral side of said outer wall of said handle when said second housing is fully seated into said second well wherein each of said first sidelong surface of said second ice scraper and said second sidelong surface of said second ice scraper are configured to inhibit the hand of the user from sliding along said second ice scraper when the user urges said handle to travel in the sideways motion on the windshield.

15. The windshield ice scraper device according to claim 13, wherein:
said windshield ice scraper device includes a first lock being movably integrated into said first housing;
said windshield ice scraper device includes a second lock being movably integrated into said upper wall of said second housing;
said second lock is biased to move upwardly from said upper wall of said second housing;
said second lock is urgeable to travel downwardly into said upper wall of said second housing wherein said second lock is configured to be depressed by the user;
said second lock extends upwardly through said second opening in said top side of said outer wall of said handle when said second housing is fully seated in said second well for removably securing said second housing in said second well; and
said second lock is displaced from said second opening when said second lock is urged to travel downwardly into said upper wall of said second housing wherein said second housing is configured to be removed from said second well when the user depresses said second lock for detaching said second ice scraper from said handle.

16. The windshield ice scraper device according to claim 15, wherein:
said windshield ice scraper device includes a second biasing member being positioned within said second housing; and
said second biasing member extends between said lower wall of said second housing and said second lock to bias said second lock to travel upwardly from said upper wall of said second housing.

17. A windshield ice scraper device for scraping ice in two directions, said device comprising:
a handle having a finger slot extending laterally through said handle wherein said finger slot is configured to have fingers of a user extended through said finger slot when the user grips said handle to enhance an ability of the user to maintain a grip on said handle, said handle having a first attachment element and a second attachment element, each of said first attachment element and said second attachment element being disposed on opposing ends of said handle, said handle having a first end and a second end and an outer wall extending between said first end and said second end, said outer wall having a top side and a bottom side and a first lateral side and a second lateral side, said bottom side curving upwardly toward said top side between said first end and said second end, said top side curving upwardly away from said bottom side between said first end and said second end, said top side having a radius of curvature being less than a radius of curvature of said bottom side wherein said top side is configured to conform to curvature of a palm of the hand of the user when the hand of the user is placed on said top side to grip said handle, each of said first lateral side and said second lateral side curving toward a center of said handle between said first end and said second end such that each of said first end and said second end has a width being greater than a distance between a middle point of said first lateral side and a middle point of said second lateral side wherein each of said first lateral side and said second lateral side are configured to orient the hand of the user to extend between said middle point of said first lateral side and said middle point of said second lateral side when the hand of the user is placed on said top side to grip said handle, said finger slot extending through said first lateral side and said second lateral side wherein said finger slot is configured to have the fingers of the user curling into said finger slot when the hand of the user is positioned to extend between said middle point of said first lateral side and said middle point of said second lateral side, said finger slot being elongated along an axis extending between said first end and said second end wherein said finger slot is configured to accommodate all of the fingers of the user when the user grips said handle, said finger slot having a bounding surface, said bounding surface having a primary end and a secondary end and a lower side and an upper side, each of said lower side and said upper side extending between said primary end and said secondary end, each of said primary end and said secondary end being rounded such that said finger slot has an ovoid shape wherein said finger slot is configured to accommodate curvature of the fingers of the user when the fingers of the user are curled into said finger slot, said lower side of said bounding surface being co-arcuate with said bottom side of said outer wall of said handle, said upper side of said bounding surface being co-arcuate with said top side of said outer wall of said handle, said finger slot being centrally located between said first end and said second end wherein said finger slot is configured to centrally locate the hand of the user on said top side of said outer wall when the user grips said handle, said first end having a first well extending toward said second end, said first well being positioned closer to said top side of said outer wall of said handle than said bottom side of said outer wall of said handle, said handle having a first opening extending through said top side of said outer wall and into said first well, each of said first well and said first opening defining said first attachment element of said handle, said first opening being elongated along an axis extending between said first lateral side and said second lateral side of said outer wall of said handle, said first opening being positioned between said first end and said primary end of said bounding surface of said finger slot, said second end having a second well extending toward said first end, said second well being positioned closer to said top side of said outer wall of said handle than said bottom side of said outer wall of said handle, said handle having a second opening extending through said top side of said outer wall and into said second well, each of said second well and said second opening defining said second attachment element of said handle, said second opening being elongated along said axis extending between said first lateral side and said second lateral side of said outer wall of said handle, said second opening being positioned between said second end and said secondary end of said bounding surface of said finger slot;
a first ice scraper being removably attachable to said first attachment element of said handle, said first ice scraper having a first scraping edge being distally located with respect to said first attachment element when said first ice scraper is removably attached to said first attachment element wherein said first scraping edge is configured to rest against a windshield of a vehicle when the user grips said handle, said first ice scraper having an upper surface and a lower surface each extending between a rear end of said first ice scraper and said first scraping edge, said lower surface curving upwardly toward said upper surface between said rear end and said first scraping edge, said upper surface having a front portion which intersects said lower surface at an acute inside angle to define said first scraping edge, said upper surface having a rear portion extending between said rear end and said front portion, said rear portion being oriented at an obtuse inside angle with said front portion, said first ice scraper having a first sidelong surface and a second sidelong surface each extending between said first scraping edge and said rear end, each of said first sidelong surface and said second sidelong surface curving inwardly toward a center of said first ice scraper between said first scraping edge and said rear end such that said rear end has a width being less than a width of said first scraping edge wherein said first scraping edge is configured to engage a maximum width of ice on the windshield;
a first housing being coupled to and extending away from said rear end of said first ice scraper, said first housing having an upper wall lying on a plane being spaced downwardly from said rear portion of said upper surface of said first ice scraper, said first housing having a lower wall lying on a plane being spaced upwardly from said lower surface of said first ice scraper, said first housing having a rear wall extending between said upper wall and said lower wall, said first housing having a first sidelong wall and a second sidelong wall, each of said first sidelong wall and said second sidelong wall curving inwardly toward a center of said first housing between said rear end of said first ice scraper and said rear wall of said first housing, said first housing being insertable into said first well in said first end of said handle having said rear end of said first ice scrapper abutting said first end of said handle when said first housing is fully seated into said first well having said first scraping edge being oriented parallel to said first end wherein said first scraping edge is configured to scrape the ice on the windshield when the user urges said handle to travel in a sideways motion on the windshield, each of said first sidelong surface and said second sidelong surface of said first ice scraper being aligned with and being oriented co-arcuate with a respective one of said first lateral side and said second lateral side of said outer wall of said handle when said first housing is fully seated into said first well wherein each of said first sidelong surface and said second sidelong surface are configured to inhibit the hand of the user from sliding along said first ice scraper when the user urges said handle to travel in the sideways motion on the windshield;
a plurality of first ridges, each first ridge of said plurality of first ridges being coupled to and extending upwardly from said rear portion of said upper surface of said first ice scraper wherein said plurality of first ridges is configured to engage the ice on the windshield when the user orients said first ice scraper in an inverted orientation on the windshield to break the ice, each first ridge of said plurality of first ridges having a forward surface being oriented perpendicular to a rear surface to define a point wherein said point of each first ridge of said plurality of first ridges is configured to penetrate the ice to break the ice, said plurality of first ridges being evenly spaced apart from each other and being distributed between said first sidelong surface and said second sidelong surface of said first ice scraper, said plurality of first ridges being positioned closer to said front portion of said upper surface of said first ice scraper than said rear end of said first ice scraper;
a first lock being movably integrated into said upper wall of said first housing, said first lock being biased to move upwardly from said upper wall, said first lock being urgeable to travel downwardly into said upper wall wherein said first lock is configured to be depressed by the user, said first lock extending upwardly through said first opening in said top side of said outer wall of said handle when said first housing is fully seated in said first well for removably securing said first housing in said first well, said first lock being displaced from said first opening when said first lock is urged to travel downwardly into said upper wall wherein said first housing is configured to be removed from said first well when the user depresses said first lock for detaching said first ice scraper from said handle;
a first biasing member being positioned within said first housing, said first biasing member extending between said lower wall of said first housing and said first lock to bias said first lock to travel upwardly from said upper wall of said first housing;
a second ice scraper being removably attachable to said second attachment element of said handle, said second ice scraper having a second scraping edge being distally located with respect to said second attachment element when said second ice scraper is removably attached to said second attachment element wherein said second scraping edge is configured to rest against the windshield of the vehicle when the user grips said handle, said handle being structured to curve upwardly between said first attachment element and said second attachment element wherein each of said first ice scraper and said second ice scraper is configured to be directed at a downward angle onto the windshield when the user grips said handle such that each of said first scraping edge and said second scraping edge is positioned at a preferred orientation with the windshield to scrape the ice from the windshield, said second ice scraper having an upper surface of said second ice scraper and a lower surface of said second ice scraper each extending between a rear end of said second ice scraper and said second scraping edge, said lower surface of said second ice scraper curving upwardly toward said upper surface of said second ice scraper between said rear end of said second ice scraper and said second scraping edge, said upper surface of said second ice scraper having a forward portion which intersects said lower surface of said second ice scraper at an acute inside angle to define said second scraping edge, said upper surface of said second ice scraper having a back portion extending between said rear end of said second ice scraper and said forward portion, said back portion being oriented at an obtuse inside angle with said forward portion, said second ice scraper having a first sidelong surface of said second ice scraper and a second sidelong surface of said second ice scraper each extending between said second scraping edge and said rear end of said second ice scraper, each of said first sidelong surface of said second ice scraper of and said second sidelong surface of said second ice scraper curving inwardly toward a center of said second ice scraper between said second scraping edge and said rear end of said second ice scraper such that said rear end of said second ice scraper has a width being less than a width of said second scraping edge wherein said second scraping edge is configured to engage a maximum width of ice on the windshield;
a second housing being coupled to and extending away from said rear end of said second ice scraper, said second housing having an upper wall of said second housing lying on a plane being spaced downwardly from said back portion of said upper surface of said second housing, said second housing having a lower wall of said second housing lying on a plane being spaced upwardly from said lower surface of said second housing, said second housing having a rear wall of said second housing extending between said upper wall of said second housing and said lower wall of said second housing, said second housing having a first sidelong wall of said second housing and a second sidelong wall of said second housing, each of said first sidelong wall of said second housing and said second sidelong wall of said second housing curving inwardly toward a center of said second housing between said rear end of said second ice scraper and said rear wall of said second housing, said second housing being insertable into said second well in said second end of said handle having said rear end of said second ice scraper of said second ice scrapper abutting said second end of said handle when said second housing is fully seated into said second well having said second scraping edge being oriented parallel to said second end wherein said second scraping edge is configured to scrape the ice on the windshield when the user urges said handle to travel in the sideways motion on the windshield, each of said first sidelong surface of said second housing and said second sidelong surface of said second housing being aligned with and being oriented co-arcuate with a respective one of said first lateral side and said second lateral side of said outer wall of said handle when said second housing is fully seated into said second well wherein each of said first sidelong surface of said second housing and said second sidelong surface of said second housing are configured to inhibit the hand of the user from sliding along said second ice scraper when the user urges said handle to travel in the sideways motion on the windshield;
a plurality of second ridges, each second ridge of said plurality of second ridges being coupled to and extending upwardly from said back portion of said upper surface of said second ice scraper wherein said plurality of second ridges is configured to engage the ice on the windshield when the user orients said second ice scraper in an inverted orientation on the windshield to break the ice, each second ridge of said plurality of second ridges having a front surface of a respective second ridge being oriented perpendicular to a back surface of said respective second ridge to define a point of said respective second ridge wherein said point of each second ridge of said plurality of second ridges is configured to penetrate the ice to break the ice, said plurality of second ridges being evenly spaced apart from each other and being distributed between said first sidelong surface of said second ice scraper and said second sidelong surface of said second ice scraper, said plurality of second ridges being positioned closer to said forward portion of said upper surface of said second ice scraper than said rear end of said second ice scraper;
a second lock being movably integrated into said upper wall of said second housing, said second lock being biased to move upwardly from said upper wall of said second housing, said second lock being urgeable to travel downwardly into said upper wall of said second housing wherein said second lock is configured to be depressed by the user, said second lock extending upwardly through said second opening in said top side of said outer wall of said handle when said second housing is fully seated in said second well for removably securing said second housing in said second well, said second lock being displaced from said second opening when said second lock is urged to travel downwardly into said upper wall of said second housing wherein said second housing is configured to be removed from said second well when the user depresses said second lock for detaching said second ice scraper from said handle; and
a second biasing member being positioned within said second housing, said second biasing member extending between said lower wall of said second housing and said second lock to bias said second lock to travel upwardly from said upper wall of said second housing.
